(19) United States
(12) Patent Application Publication
(10) Pub. No.: US 2014/0349214 A1
(43) Pub. Date: Nov. 27, 2014

(54) Device For Cooling And Dehumidifying Gases, Method For Cooling And Dehumidifying Gases, And Vehicle With A Fuel Cell System And A Device For Cooling And Dehumidifying Fuel Cell Exhaust Air

(71) Applicant: Airbus Operations GmbH, Hamburg (DE)

(72) Inventor: Felix Frederik Oehme, Hamburg (DE)

(73) Assignee: Airbus Operations GmbH, Hamburg (DE)

(21) Appl. No.: 14/283,285

(22) Filed: May 21, 2014

(30) Foreign Application Priority Data
May 22, 2013 (DE) 10 2013 105 215.0

(51) Int. Cl. H01M 8/04

(52) U.S. Cl. CPC H01M 8/04843
USPC 429/513; 62/285; 62/93

(57) ABSTRACT

A device for cooling and dehumidifying gases includes a first hollow body with a gas inlet, a gas outlet and a condensate drain; a second hollow body with a coolant inlet and a coolant outlet; and a drive unit. The first hollow body encloses the second hollow body at least in part. One of the first hollow body and the second hollow body is pivotally held relative to the other hollow body and includes at least one turbulence-generating body that extends in the direction of the other hollow body. For rotating the pivotally held hollow body the drive unit is couplable to the hollow body. In this manner a single-stage device for cooling and dehumidifying gases that include water vapor is implemented, which device requires little installation space and is of a particularly lightweight construction. Thus the device is particularly well suited for use in vehicles, in particular in aircraft.

### TECHNICAL FIELD

The invention relates to a device for cooling and dehumidifying gases, to a method for cooling and dehumidifying gases, to a vehicle with a fuel cell system, and to a device for cooling and dehumidifying fuel cell exhaust air.

### BACKGROUND OF THE INVENTION

For cooling and drying warm gases that contain water vapor, in the state of the art heat transfer devices and phase separation devices arranged downstream of the aforesaid are commonly used through which devices gas flows. In the heat transfer device energy in the form of heat is transferred from the gas to a fluid whose temperature is lower than that of the gas, wherein the gas stream is typically separated from the cold fluid stream by an impermeable wall. As a result of cooling of gas to below the dewpoint of water, part of the water vapor contained in the gas condenses so that a two-phase mixture comprising liquid water and humid gas is present. In the phase separation device arranged downstream the liquid phase is separated, wherein the degree of separation, in particular in the case of phase separation devices based on cyclone technology, greatly depends on the flow speed of the gas stream.

Furthermore, devices are known that by cooling the gas stream to below the freezing point of water assist the accumulation of ice, and by melting or removing the ice lead the humidity away. For example WO 2011/036027 A1 discloses a system for drying exhaust gases of a fuel cell system, which system for drying comprises two heat exchangers that are alternatingly subjected to the flow of exhaust gas, which heat exchangers by means of a coolant cause icing and accumulation of water vapor from the exhaust gas, wherein the accumulated ice is alternatingly melted and led away. WO 2011/051210 A1 furthermore discloses a dehumidifier for exhaust air of a fuel cell, in which dehumidifier the exhaust air is guided over a cold surface so that the water vapor contained therein condenses and freezes and, by means of a device, is subsequently scraped off from the surface and led away.

### BRIEF SUMMARY OF THE INVENTION

A separate design of cooling devices and dehumidifying devices is associated with the need for more installation space and with increased weight, which is to be avoided, in particular, in the intended use of such devices in an aircraft. Moreover, the transfer of heat from a gas stream to a cooler liquid, for example to an incompressible liquid, results in the transferable thermal output typically being limited by the average heat transfer coefficient on the gas side. While the transferable thermal output may be improved by enlarging surfaces on the gas side by means of fins or other devices, this is, however, associated with an additional drop in pressure. In the case of very considerable water loads, wetting a heat-transferring surface with condensate on the gas side may, moreover, result in an increase in the thermal resistance and in the drop in pressure. Furthermore, in partial condensation of a gas mixture the share of the corresponding gas components at the location of condensation drops, which results in additional thermal resistance.

It is thus an aspect of the invention to propose a device that carries out reliable, efficient and even cooling and dehumidifying of a gas, while at the same time requiring little installation space and being of a lightweight construction.

A device for cooling and dehumidifying air is proposed. The device comprises a first hollow body with a gas inlet, a gas outlet and a condensate drain at a bottom side of the first hollow body. The device further comprises a second hollow body with a coolant inlet and a coolant outlet and a drive unit. The first hollow body encloses the second hollow body at least in part. One of the first and of the second hollow bodies is pivotally held relative to the other hollow body and comprises at least one turbulence-generating body that extends in the direction of the other hollow body. For rotating the pivotally held hollow body the drive unit is couplable to said hollow body.

A core component of the device according to an embodiment of the invention thus relates to a heat transfer arrangement comprising two hollow bodies that are arranged one inside the other. The hollow bodies are designed to be subjected to a fluid flow. In this design the particular shape of the hollow bodies in a given application is immaterial, provided the function of the passing through of the fluid is ensured. In order to ensure thermal transfer from a fluid passing through the second hollow body to a fluid passing through the first hollow body, an adequately dimensioned space between the hollow bodies should be provided. The boundary surface responsible for thermal transfer is defined by the jacket of the second hollow body. Particularly preferably, the hollow bodies are implemented as tubular components, wherein at least the pivotally held hollow body has a rotationally symmetrical shape that prevents uneven rotation and thus vibration.

The condensate drain is preferably an opening that is situated at the bottom side of the heat exchanger arrangement and that makes it possible for the condensate to drain. Due to gravity, in particular after an inner surface of the first hollow body has been wetted, the condensate endeavors to flow in a gravity-driven manner to the bottom side of the heat exchanger arrangement. As a result of a connection of the condensate drain to a line or to a reservoir, the use of the condensate outside the device may take place.

The second hollow body has a coolant inlet and a coolant outlet by way of which a coolant may flow through the second hollow body. Due to the at least partial enclosure of the second hollow body by the first hollow body, a gas that by way of the gas inlet and the gas outlet flows through the first hollow body may be cooled as a result of contact with the outer surface of the second hollow body. Consequently, water vapor contained in the gas may condense as a result of cooling, and is then led away in a gravity-driven manner from the first hollow body by way of the condensate drain at the bottom side.

In order to increase the efficiency of the condensation process the pivotally held hollow body comprises turbulence-generating elements that preferably are rigidly attached to the surface of the hollow body, which surface is in contact with the gas stream, and during rotation in the space between the first hollow body and the second hollow body are moved by the gas streaming through. In this manner the gas stream is made to rotate so that as a result of centrifugal force the condensed water is forced to the inside of the first hollow body and from there flows to the condensate drain at the bottom side of the exchanger arrangement.

Of course, it must be ensured that the coolant inlet, the coolant outlet, the gas inlet, the gas outlet and the condensate drain are not adversely affected by rotation of one of the hollow bodies, and that interference-free inflow and outflow of all the fluids are possible in all the operating states of the device. For example, the gas inlet, the gas outlet, the coolant inlet and the coolant outlet may each comprise a fluid coupling or a rotary seal with lamellae, a labyrinth arrangement or similar devices that allow loss-free channeling of the particular fluid from a fixed part to a rotating hollow body.

This results in a number of advantages when compared to known devices from the state of the art. Firstly, the degree of separation may be independent of the flow speed of the gas stream, which instead essentially depends on the rotary speed of the pivotally held hollow body. The device may thus accomplish a very high degree of separation in various operating states of a device that gives off a humid gas. As a result of rotation of the hollow body in question, furthermore, the relative speed between the air and the cooling-active wall surface increases, which results in an increase in the average thermal transfer coefficient on the gas side, which is still further improved by an increase in the voracity of the gas stream. The action of centrifugal force on the condensate results in accelerated removal, and consequently any accumulation of condensate on all the heat-transferring walls or the formation of a film is largely avoided. As a result of the rotating turbulence-generating elements, furthermore, increased mixing within the gas stream takes place, which results in a reduction in the partial pressure differences and thus in an improvement of the condensation capacity. Since, furthermore, the device according to the invention comprises a very compact design, this results in a significantly reduced requirement in terms of installation space, and in lighter weight when compared to devices that are arranged separately and connected in sequence. Consequently, the device according to an embodiment of the invention is particularly well suited for use in vehicles, and in particular in aircraft.

For interference-free rotation the at least one turbulence-generating body extends from the pivotally held hollow body to the other hollow body in such a manner that the latter is not contacted by the at least one turbulence-generating body. Imparting a rotatory component to the gas flow may also take place by means of turbulence-generating elements that do not extend across the entire space between the two hollow bodies.

In a particularly advantageous embodiment, the second hollow body is pivotally held relative to the first hollow body in order to be able to support somewhat higher rotary speeds, and so that mounting the first hollow body because of its smaller diameter, when compared to the second hollow body, may be implemented more simply and economically.

In an advantageous embodiment the drive unit comprises an axial turbine that is couplable to the pivotally held hollow body and that projects into the space between the first and the second hollow bodies. As a result of a gas flow present within the space between the first hollow body and the second hollow body the axial turbine is impinged by the gas flow and is consequently made to rotate. As a result of coupling to the pivotally held hollow body, the aforesaid is driven by the axial turbine. The axial turbine could, for example, be arranged directly on an outer lateral surface of the second hollow body or on an inner jacket surface of the first hollow body so that a mechanically very simple design results. As an alternative to this, as a result of the arrangement of a reduction gear unit between the axial turbine and the pivotally held hollow body a lower necessary torsional moment of the axial turbine may be achieved, which is accompanied by a higher rotary speed of the turbine.

Furthermore, it is to be considered to be particularly advantageous to pivotally hold the second hollow body and to arrange the axial turbine within the second hollow body. The coolant flowing in through the coolant inflow flows to the axial turbine and causes the second hollow body to rotate. The space between the first and the second hollow bodies is not occupied by the axial turbine, and consequently the gas flow is without disturbance. Furthermore, the arrangement within the second hollow body suggests itself because, depending on the source of the coolant, the coolant stream may be largely constant and consequently causes constant rotation of the second hollow body. The use of a liquid coolant that has a higher density than the gas stream makes it possible to design the axial turbine with a significantly smaller incident flow surface and thus with a significantly reduced size.

In an alternative embodiment of the device the drive unit comprises an electric motor that is couplable to the pivotally held hollow body. In this manner a rotational speed may be achieved that is independent of the gas stream. The degree of separation attained with this arrangement may also be improved completely independently of the flow speed of the gas stream.

In a particularly preferred embodiment the gas inlet is arranged at the top of the first hollow body, and the gas outlet is arranged at the bottom side of the first hollow body, while the coolant inlet is arranged at a bottom side of the second hollow body, and the coolant outlet is arranged at the top of the second hollow body. Arranging the gas inlet at the top, and arranging the gas outlet at the bottom side results in support of a movement of the forming condensate droplets to the condensate drain, already due to the direction of the gas flow, wherein the opposite direction of flow of the coolant results in taking advantage of the counter-flow principle, in which there is always an adequate temperature gradient between the coolant stream and the gas stream.

Preferably, the condensate drain comprises a level-activateable opening device that then carries out opening of the condensate drain as soon as a predetermined quantity of condensate has collected at the bottom side of the device. The level-activateable opening device may, in particular, comprise a float body that becomes buoyant as condensate collects. The float body may be directly connected to a valve which as a result of spring force remains in a closed position and may be released by the float body connected by way of a fastening means. As an alternative or in addition, the float switch may also be connected to a sensor or a contact device so that an electrically activateable drain valve may be controlled as soon as a predetermined level has been reached. In the design of the level-activateable opening device an adequate hysteresis preferably for the complete leading-away of the condensate is to be provided. With the use of the level-activateable opening device, draining of condensate takes place only when a substantial quantity of condensate is present, while most of the time the condensate drain is closed. In this way it becomes possible to prevent a constant gas flow emanating from the condensate drain.

In an advantageous embodiment the at least one turbulence-generating body is designed as a fin that extends in the radial direction from the pivotally held hollow body to the lateral surface of the other hollow body. Moreover, it is particularly advantageous to use several fins that in the circumferential direction and/or in the longitudinal direction are spaced apart from each other relative to the pivotally held hollow body. As a result of spacing in the circumferential direction, particularly good turbulence of the air flow may be achieved, an effect that may be increased still further, in particular, by a twist in individual fins. Multiple integration of fins spaced apart from each other in longitudinal direction results in an increase in the rotation energy imparted to the gas stream.

The invention further relates to a method for cooling and dehumidifying a gas, which method essentially comprises the following steps. The gas to be dehumidified and cooled is led through a gas inlet in a first hollow body to a gas outlet, at the same time a coolant is led through a coolant inlet to a coolant outlet in a second hollow body that is at least partly enclosed by the first hollow body. One of the first and of the second hollow bodies is rotated relative to the other hollow body, and the gas flowing through the first hollow body is made to rotate by means of at least one turbulence-generating body on the pivotally held hollow body. In this method the temperature of the coolant is lower than the temperature of the gas flowing through the first hollow body. As a result of the temperature differential and supported by the rotation of the gas, cooling of the gas takes place so that part of the water vapor contained therein condenses and due to the centrifugal force is driven in the form of droplets to an interior lateral surface of the first hollow body, from where, driven by gravity, it reaches a drain. The method further comprises the leading away of the condensate. Rotation of one of the first and of the second hollow bodies relative to the other hollow body may comprise the incident flow to an axial turbine by the gas flow, wherein the axial turbine is coupled to the hollow body. As an alternative to this, rotation of the pivotally held hollow body relative to the other hollow body may comprise driving the pivotally held hollow body with a motor.

Finally, the invention relates to a vehicle with a fuel cell that comprises an exhaust air outlet connectable to the gas inlet of the device according to the invention. Thus on board the vehicle, it is possible to implement exhaust air drying and water extraction from operation of the fuel cell with the need for relatively little installation space and at a relatively light weight. This suggests itself in particular if the vehicle is an aircraft and if dehumidified, oxygen-depleted exhaust air is to be used for rendering inert fuel tanks, and if water is to be used for an on-board water system. The use of dehumidified or dried exhaust air makes sense because an input of humidity encourages the formation of bacteria population within the tank, which in particular could influence sensors for registering the fill level of the tank. Moreover, within the fuel tank or the fuel itself, ice crystals could form that could result in damage to engine injection nozzles or fuel filters when the aircraft is cruising or is on the ground at temperatures below freezing.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a first exemplary embodiment of a device according to the invention for cooling and dehumidifying gases.

FIG. 2 shows a second exemplary embodiment of a device according to the invention for cooling and dehumidifying gases.

FIG. 3 shows an aircraft comprising a fuel cell system and a device according to the invention for cooling and dehumidifying fuel cell exhaust air.

### DETAILED DESCRIPTION

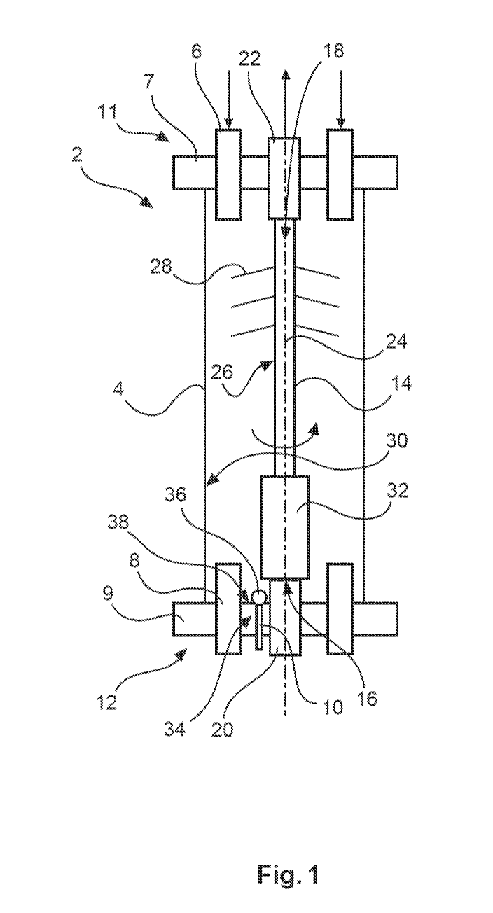

FIG. 1 shows a longitudinal section of a first exemplary embodiment of a device 2 according to an embodiment of the invention for cooling and dehumidifying a gas, which device 2 comprises a heat exchanger arrangement with a first tubular hollow body 4 with a gas inlet 6 at the top 11, a gas outlet 8 and a condensate drain 10 at the bottom side 12. The gas inlet 6 and the gas outlet 8 are designed, for example, as annular openings that comprise connection bridges, or as annular arrangements of several through-holes. The heat exchanger arrangement of the device 2 further comprises a second tubular hollow body 14 with a coolant inlet 16 and a coolant outlet 18, wherein the second hollow body 14 is completely enclosed by the first hollow body 4. By means of a bottom bearing 20 and a top bearing 22, which bearings, 20, 22 are, for example, designed as hollow rotating couplings or are combined with such a coupling, the second hollow body 14 is pivotally held relative to the first hollow body 4. Consequently, the second hollow body 14 may rotate on a longitudinal axis 24 relative to the first hollow body 4.

For sealing the first hollow body 4 and for holding the second hollow body 14, situated in said first hollow body 4, the gas inlet 6 and the gas outlet 8, a top cover 7 and a bottom cover 9 are arranged at the top 11 and at the bottom side 12 of the first hollow body 4, which covers 7, 9 by means of suitable sealing elements provide a seal and are connected by suitable means to the first hollow body 4. For example, the bottom cover 9 comprises the condensate drain 10 and serves as a bottom surface for the first hollow body 4, on which bottom surface the condensate collects.

By a reverse arrangement of the gas inlet 6 and of the coolant inlet 20 as well as of the gas outlet 8 and the coolant outlet 22 the counter-flow principle is implemented, in which as great a temperature gradient as possible between the coolant stream and the gas stream is achieved essentially along the entire extension of the hollow bodies.

Furthermore, the exemplary embodiment shown comprises a rotationally symmetrical design so that vibration-less rotation of the second hollow body 14 relative to the first hollow body 4 may take place and at the same time the space between the outer lateral surface of the second hollow body 14 and the inner lateral surface of the first hollow body 4 remains constant over the entire height of the device 2 and over the extension of the second hollow body 14. The thermal transfer between the gas stream and the coolant stream thus remains constant in the circumferential direction.

On an outer surface 26 of the second hollow body 14, turbulence-generating elements 28 are arranged which extend in three rings or rows so as to be spaced apart from each other in the longitudinal direction and which extend, for example, obliquely to the longitudinal axis 24, which turbulence-generating elements 28 are designed to cause a gas flow between the gas inlet 6 and the gas outlet 8 to rotate. In this manner the thermal transfer between the gas stream and the coolant stream is improved, and at the same time, due to centrifugal force, condensate droplets are flung to an inner lateral surface 30 of the first hollow body 4 in order to flow away from that location in the direction of the condensate drain 10. The turbulence-generating elements 28 may be designed as beveled sheet metal pieces that preferably prevent acceleration of the gas stream in the longitudinal direction, while nevertheless imparting a significant radial component. Cross-sectional profiles that comprise a main direction of extension that is preferably parallel to the longitudinal axis 24 of the device and that are circumferentially spaced apart from each other are suitable for this. As an alternative or in addition to this, arrangements of rod-shaped turbulence-generating elements 28 that are circumferentially spaced apart from each other and that have a symmetrical cross section are also imaginable.

In FIG. 1 the second hollow body 14 comprises, for example, an axial turbine 32 which when a gas flows through the first hollow body is made to rotate in order to cause the second hollow body 14 to rotate. Increasing the condensation capacity by means of the centrifugal effect correspondingly depends on the speed of the gas flow within the first hollow body 4; it suggests itself, in particular, when an adequate flow speed of the gas stream is to be expected that, in particular, remains constant or essentially constant over a predetermined period of time.

In order to prevent gas from issuing from the condensate drain 10, the latter comprises a level-activateable opening device 34 that comprises a floating body 36 that is coupled to a valve 38. The coupling is, for example, mechanical so that condensate drains from the condensate drain 10 only after a predetermined condensate level at the bottom side 12 has been reached.

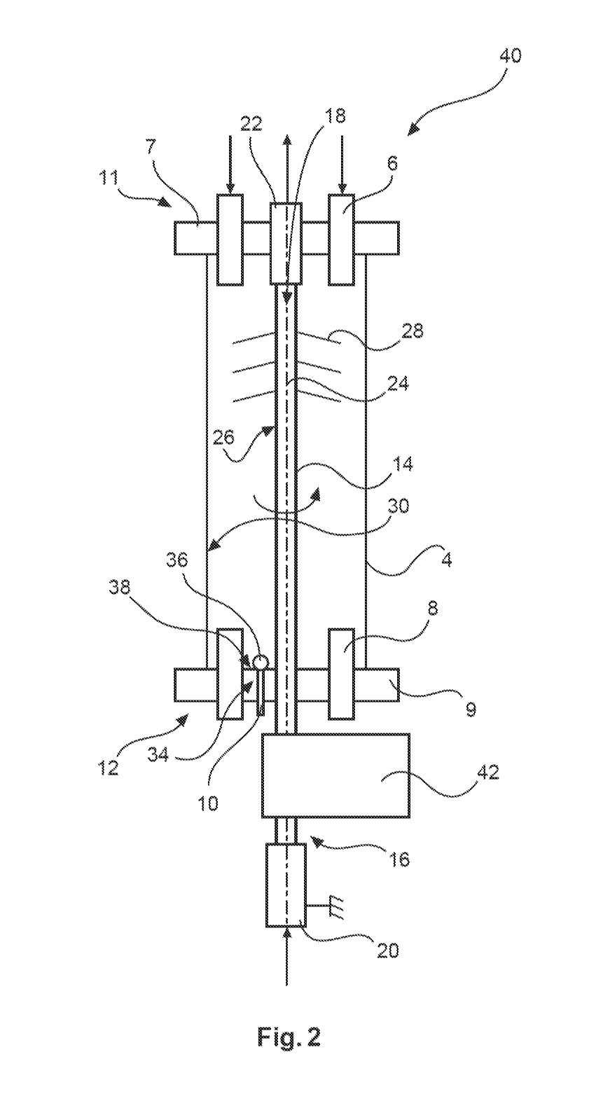

In a device 40, shown in FIG. 2, for cooling and dehumidifying gases, the second hollow body 14 is also pivotally held relative to the first hollow body 4 and comprises turbulence-generating elements 28. However, the axial turbine 32 has been replaced by a motor 42 that allows driving the second hollow body 14 relative to the first hollow body 4 even independently of the flow speed of the gas. In this manner the condensation capacity may be significantly improved even in the case of irregular flow speeds.

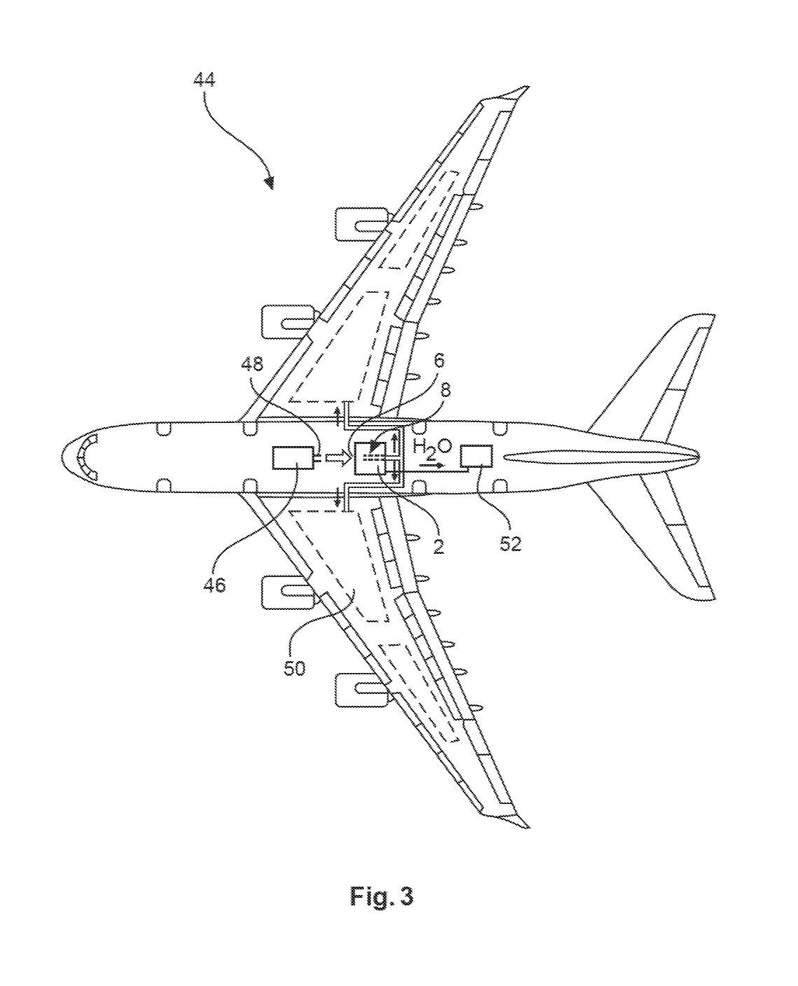

Lastly, FIG. 3 shows an aircraft 44 with a fuel cell system 46 that may be equipped with a device 2 or 40 according to the invention. The fuel cell system 46 comprises an exhaust air exit 48 that may be connected to a gas inlet 6. By means of the aforesaid the relatively humid oxygen-depleted exhaust air that arises during operation of the fuel cell system 46 may be cooled and dehumidified, for example to be useable for rendering fuel tanks 50 inert. At the same time the condensate arising during dehumidification may be conveyed to a water system 52.

By means of the single-stage design according to an embodiment of the invention a lighter weight and a reduced requirement for installation space is implemented. At the same time, effective dehumidification of modern fuel cell systems may take place in which the compressor output required for the cathode-air supply may be reduced, and consequently a relatively low gas mass flow may be achieved, which would be unlikely to be adequate for operation of a conventional cyclone separator. Furthermore, as a result of the reduction of the energy required for operation, the use in an aircraft is advantageous, because generating simple rotation without compression work is considerably more favorable than an alternative increase in the mass flow by means of an additional compressor.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

1. A device for cooling and dehumidifying gases, comprising:
a first hollow body with a gas inlet, a gas outlet and a condensate drain,
a second hollow body with a coolant inlet and a coolant outlet, and
a drive unit,
wherein the first hollow body encloses the second hollow body at least in part,
wherein one of the first hollow body and the second hollow body is pivotally held relative to the other hollow body and comprises at least one turbulence-generating body extending in the direction of the other hollow body, and
wherein for rotating the pivotally held hollow body the drive unit is couplable to the hollow body.

2. The device of claim 1, wherein the condensate drain is arranged at a bottom side of the first hollow body.

3. The device of claim 1, wherein the at least one turbulence-generating body extends from the pivotally held hollow body to the other hollow body in such a manner that the other hollow body is not contacted by the at least one turbulence-generating body.

4. The device of claim 1, wherein the second hollow body is pivotally held relative to the first hollow body.

5. The device of claim 1, wherein the drive unit comprises an axial turbine couplable to the pivotally held hollow body.

6. The device of claim 1, wherein the drive unit comprises an electric motor couplable to the pivotally held hollow body.

7. The device of claim 1,
wherein the gas inlet is arranged at the top of the first hollow body, and the gas outlet is arranged at the bottom side of the first hollow body, and
wherein the coolant inlet is arranged at the bottom side of the second hollow body, and the coolant outlet is arranged at the top of the second hollow body.

8. The device of claim 1, wherein the condensate drain comprises a level-activateable opening device configured to open the condensate drain as soon as a predetermined quantity of condensate has collected in the first hollow body.

9. The device of claim 1, wherein the at least one turbulence-generating body is configured as a fin or a plurality of fins spaced apart from each other in circumferential direction.

10. A method for cooling and dehumidifying gases, the method comprising:
leading a gas to be cooled and dehumidified through a gas inlet by way of a first hollow body to a gas outlet,
leading a coolant through a coolant inlet to a coolant outlet by way of a second hollow body at least partly enclosed by the first hollow body,
rotating one of the first hollow body and the second hollow body and an at least one turbulence-generating body arranged thereon relative to the other hollow body, which turbulence-generating body extends in the direction of the other hollow body, and
leading away condensate that collects in the first hollow body.

11. The method of claim 10, wherein rotating one of the first hollow body and of the second hollow body relative to the other hollow body comprises the incident flow to an axial turbine by the flowing gas between the gas inlet and the gas outlet.

12. The method of claim 10, wherein rotating one of the first hollow body and of the second hollow body relative to the other hollow body comprises the incident flow to an axial turbine by the flowing coolant within the second hollow body.

13. The method of claim 10, wherein rotating one of the first hollow body and the second hollow body relative to the other hollow body comprises the driving by a motor.

14. A vehicle comprising a fuel cell with an exhaust air outlet connectable to the gas inlet of a device comprising:
a first hollow body with a gas inlet, a gas outlet and a condensate drain;
a second hollow body with a coolant inlet and a coolant outlet; and
a drive unit;
wherein the first hollow body encloses the second hollow body at least in part,
wherein one of the first hollow body and the second hollow body is pivotally held relative to the other hollow body and comprises at least one turbulence-generating body extending in the direction of the other hollow body, and
wherein for rotating the pivotally held hollow body the drive unit is couplable to the hollow body.

15. The vehicle of claim 14, wherein the gas outlet is connectable to an inert gas inlet of a fuel tank for rendering it inert.
